(19) United States
(12) Patent Application Publication
(10) Pub. No.: US 2010/0244348 A1
(43) Pub. Date: Sep. 30, 2010

(54) Adjustable C-clamp

(76) Inventors: Stephen Castor, Los Angeles, CA (US); Justin Blake Castor, Los Angeles, CA (US); Brandon Castor, Los Angeles, CA (US)

Correspondence Address: John Alumit, 16830 Ventura Blvd. Suite 360, Encino, CA, 91436, US

(21) Appl. No.: 12/383,710

(22) Filed: Mar. 30, 2009

(51) Int. Cl. B25B 1/02

(52) U.S. Cl. 269/165

(57) ABSTRACT

A C-clamp with an expeditious adjustment feature. The C-clamp comprises a C-frame having a seat pad and a hole at its either ends. A cylinder is to be received within the hole; the cylinder in turn carrying a clamp rod, which is used for pressing a work piece against the seat pad. The cylinder and the hole permit the clamp rod both to be rotated and to be freely pushed through the cylinder against the seat pad.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to work piece-holding devices and more particularly to C-clamps and even more particularly to a C-clamp with an expeditious adjustment feature.

A C-clamp typically includes a C-frame and a threaded rod to be used in conjunction with the C-frame. The C-frame comprises a pair of oppositely faced arms, namely first and second arms, both connected by an intermediate arm. The ends of the first and the second arms include a seat pad and a threaded hole respectively; the seat pad for providing a gripping surface. The threaded rod is to be received within the threaded hole. One end of the threaded rod includes a shoe member that faces the seat pad of the first arm. The other end of the threaded rod includes a handle. The handle can be rotated in either direction so that the threaded rod can be moved thread-by-thread in a forward or backward direction. Generally, to make use of the C-clamp, a work piece/work pieces are placed between the shoe member and the seat pad. The handle of the threaded rod is rotated until the work piece/work pieces are firmly secured between the seat pad and the shoe member.

C-clamps are generally made of different sizes, ranging from small to large. The operation of the C-clamps, especially the larger ones, is inefficient because the threaded rod has to be rotated so that its entire length has to advance thread-by-thread until the work piece is firmly clamped. This process becomes all the more difficult and strenuous when smaller and/or thinner work pieces are to be clamped. This is because the thinner/smaller the work piece, the more thread-by-thread displacement of the threaded rod required. Thus, more time and efforts is required. To overcome this problem, it is desirable to move or slide the threaded rod rapidly, without having to rotate it, over a considerable distance until the work piece is gripped, and then secure the work piece firmly by rotating the threaded rod. Several C-clamps which facilitate this expeditious movement of the threaded rod are known in the art.

For example, U.S. Pat No. 4,627,604 to Choi discloses a multi-element C-clamp having a work piece-gripping surface at a gripping arm on one end piece, and a gripping element supported from a cooperating gripping arm of a second end piece; the gripping element being advanced as rotated. A spring biased locking lever locks the end pieces in predetermined juxtaposition with respect to one another, with one non-gripping arm of one end piece inserted into a corresponding non-gripping hollow arm of the other end piece. Security latches are provided in the locking levers to ensure against accidental disengagement of end pieces during use. Although the C-clamp and the present invention serve the same purpose, the present invention is structurally distinguishable as it needs to be manipulated at the point where the clamp rod and the C-frame are coupled to achieve the purpose.

U.S. Pat. No. 6,296,241 to Harrison discloses an adjustable C-clamp, which includes a C-shaped frame fitted with parallel bottom and top clamp seats and a clamp cylinder at the top clamp seat. A slotted cylinder is secured in the clamp cylinder by an Allen screw. A clamp rod disposed in the slotted cylinder is fitted with a clamp rod pin. A clamp nut typically attached to one end of the clamp rod faces the bottom clamp seat across the expanse of the clamp frame. The clamp rod pin is designed to slide through a pair of parallel, diametrically-opposed longitudinal cylinder slots in the slotted cylinder to facilitate adjusting the clamp rod in the slotted cylinder and quickly positioning the clamp nut at a selected spacing from the bottom clamp seat. By rotation of the clamp rod in the slotted cylinder, the clamp rod pin is seated in a selected pair of multiple spaced-apart pin slots extending from the respective longitudinal cylinder slots in diametrically opposed relationship with respect to each other. Continued rotation of the clamp rod facilitates threaded extension of the clamp cylinder through the top clamp seat and advancement of the clamp nut against the bottom clamp seat. In another embodiment, the slotted cylinder is omitted and the longitudinal cylinder slots and respective sets of pin slots are provided in the clamp cylinder.

U.S. Pat. No. 5,423,525 to Spainhower discloses a C-clamp comprising a C-shaped body. The body comprises a first end and a second end, the first and the second ends terminating in an anvil and a base respectively. The base includes an opening. Further, the base includes a first member and a second member, both pivotally connected thereon. The first and second members are operative between open and second positions. In the closed position, the first and the second members are joined together to form an aperture that is aligned with the opening in the base; the aperture being internally threaded. In the open position, the first and the second members are tilted sideward in opposite directions whereby the aperture is divided longitudinally. The first and second members are operated between the open and closed position by means of a latch. The C-clamp further comprises a screw which includes a foot and a rod at either end, the rod acting as a handle. The screw is disposed within the opening and the aperture such that the foot and the anvil are oppositely located. The screw can be slid within the opening when the first and the second members are in the open position. However, when the first and the second members are in closed position, the screw needs to be rotated so as to advance it in forward or backward direction. Therefore, to make use of the C-clamp, a work piece is to be placed across the expanse of the C-shaped body and the screw is to be freely pushed until the work piece is gripped in between the foot and the anvil. Then the latch is to be released, so that the first and second members engage in closed position. Subsequently, the screw is rotated until the work piece is tightly clamped.

Although the above references facilitate an expeditious adjustment of the C-clamps, the present invention differs from the above inventions in that the present invention employs a groove and locking device mechanism to secure a clamp rod and facilitate efficient clamping and unclamping of a work piece.

Therefore, it is an objective of the present invention to provide a C-clamp with an expeditious movement/adjustment feature so as to avoid thread-by-thread advancement of the clamp rod for clamping a work piece.

A further object is to provide a means for facilitating expeditious adjustment at the point where the C-frame and the clamp rod are coupled.

Finally, it is an object of the present invention to provide the expeditious adjustment feature by employing a cylinder with a bore, at least one groove, a locking device, and a clamp rod thereby differentiating the present invention from the above references and other related art. These and other objects of the present invention will become better understood with reference to the appended Summary, Description, and Claims.

### SUMMARY

The present invention is an adjustable C-clamp comprising a clamp rod and a C-frame, which in turn comprises first and second arms. The ends of the first and the second arms comprise a seat pad and hole respectively. The clamp rod is engaged with the C-frame. The clamp rod includes a shoe member at one of its end.

The C-clamp further comprises a cylinder that is to be received within the hole. The cylinder contains a bore and thus, comprises an exterior and interior side. The interior includes at least one groove. At least one end of the groove terminates in a shallow end or another groove that is shallower than the first groove. The interior further comprises a locking device initially located within the groove. The clamp rod is to be disposed within the interior such that the seat pad and the shoe member are oppositely faced. The clamp rod can slide within the interior.

To make use of the C-clamp, the clamp rod is pushed until a work piece is gripped between the shoe member and the seat pad. The clamp rod is then rotated in a first direction so that the locking device moves towards the shallow end of the groove. At this point the clamp rod gets substantially locked within the interior of the cylinder. Further rotation of the clamp rod in the same direction enables a tighter gripping on the work piece due to extension of the cylinder along with the clamp rod thereby producing the desired clamping effect. Rotating the clamp rod in a second direction followed by sliding it backwards disengages the work piece from the C-clamp.

### BRIEF DESCRIPTION OF THE FIGURES

FIG. 1 is a perspective view of the C-clamp in accordance with the present invention.

FIG. 2 is a plan view of the dissembled C-clamp in accordance with the present invention.

FIG. 3 is a side perspective view of the cylinder in accordance with the present invention.

FIG. 4 is a front perspective view of the cylinder in accordance with the present invention.

FIG. 5 is a perspective view of the cylinder with the clamp rod disposed within it in accordance with the present invention.

FIGS. 6 through 8 are the illustrations of the sequential operations involved in locking the clamp rod within the cylinder in accordance with the present invention.

FIG. 9 is a perspective view of the C-clamp holding a work piece in accordance with the present invention.

FIG. 10 is a front perspective view of the cylinder employed with locking devices of ball bearings in accordance with the present invention.

FIG. 11 is a front sectional view of the cylinder with two primary grooves it in accordance with the present invention.

FIG. 12 is a perspective view of the c-clamp without the cylinder in accordance with the present invention.

### FIGURES-REFERENCE NUMERALS

100 . . . Adjustable C-clamp
110 . . . Handle
120 . . . C-frame
130 . . . First Arm
140 . . . Second Arm
150 . . . Intermediate Arm
160 . . . Cylinder
170 . . . Clamp Rod
180 . . . Shoe Member
190 . . . Seat Pad
200 . . . Ridge
210 . . . Locking device
220 . . . Hole
300 . . . Bore
400 . . . Interior
410 . . . Groove
900 . . . Work Piece
1000 . . . Bearings

### DETAILED DESCRIPTION

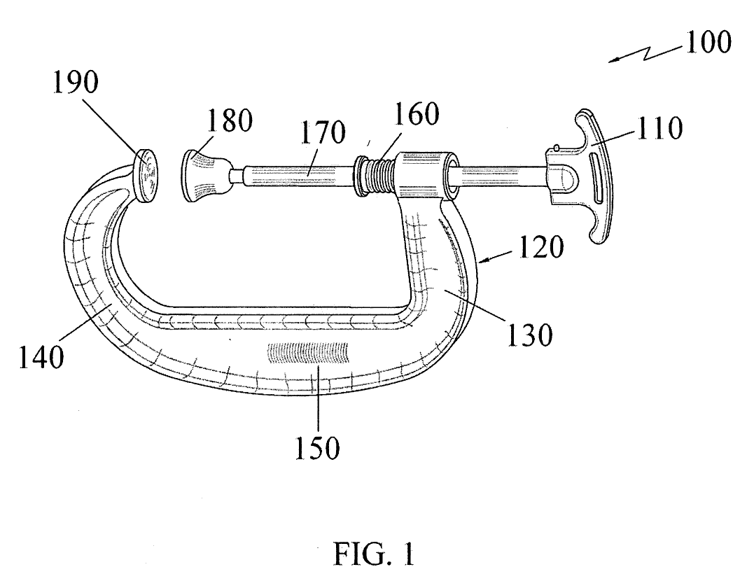

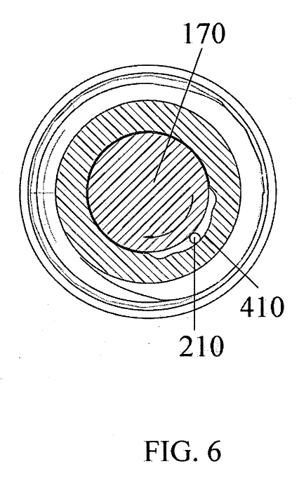

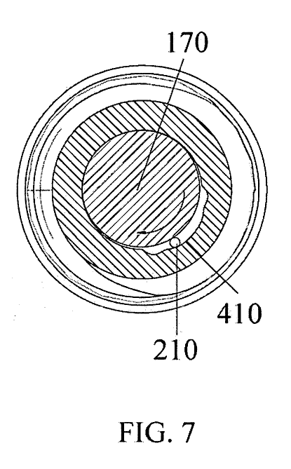

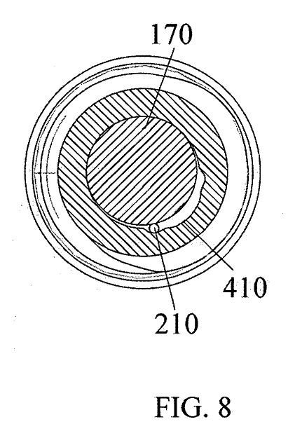

Referring to the drawings, a preferred embodiment of an adjustable C-clamp 100 is illustrated in FIGS. 1 through 12. Referring to FIG. 1, the C-clamp 100 comprises a handle 110, C-frame 120, a first arm 130, a second arm 140, an intermediate arm 150, a cylinder 160, a clamp rod 170, a shoe 180, and a seat pad 190. The C-frame 120 is defined by first arm 130 and second arm 140 which are oppositely faced. The first and second arms, 130 and 140, are connected by an intermediate arm 150. The ends of the second arm 140 comprising a seat pad 190. The seat pad 190 may include a gripping surface such as grooves, ridges, additional gripping materials or the like attached to the seat pad 190, to further improve the gripping ability of the seat pad 190. The shoe 180, like the seat pad 190, may also have a gripping surface such as grooves, ridges, additional gripping materials or the like to further improve the gripping ability of the shoe 180. The connection of shoe 180 to clamp rod 170 may be a ball and joint assembly to allow for flexibility of the shoe 180. Shoe 180 and handle 110 are detachable from clamp rod 170. The C-frame 120 can be made of any materials such as metal, iron, bronze, steel, aluminum, wood or plastic depending on its use.

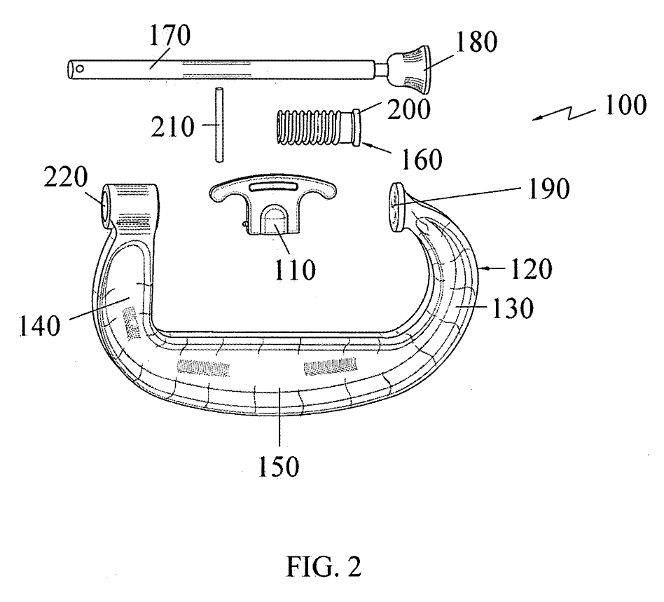

Referring to FIG. 2, which shows the C-clamp 100 of the present invention disassembled, further shows ridge 200, locking device 210, and hole 220. Ridge 200 which may be a part of cylinder 160 keeps the cylinder 160 from sliding through hole 220. Hole 220 may include threads or other means of retaining cylinder 160. Locking device 210 while shown as a rod may be a rod, cylinder, sphere, or any other shape and may be magnetized to better adhere to clamp rod 170.

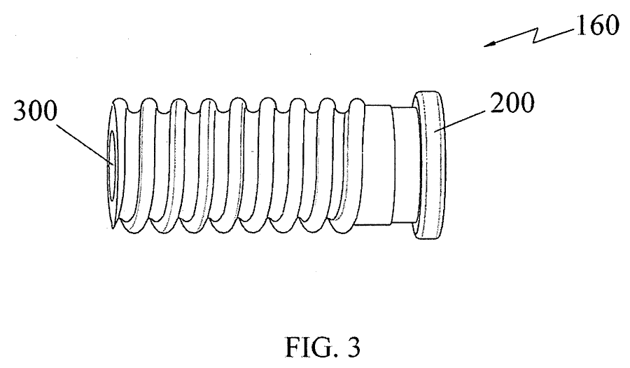

Referring to FIG. 3, which shows cylinder 160, may be made of metal, iron, bronze, steel, aluminum, wood, or the like. Cylinder 160 contains bore 300 and may also include threads on the exterior of the cylinder 160 such that when inserted into hole 220, the threads of cylinder 160 would engage the threads of hole 220.

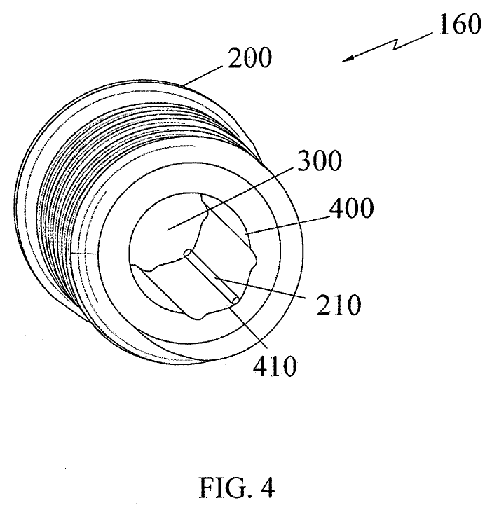

Referring to FIG. 4, cylinder 160 is shown with a bore. On the bore side or interior 400 of cylinder 160 is groove 410. Groove 410 includes at least one shallow end or a secondary groove that is shallower than groove 410. Inside groove 410 is locking device 210.

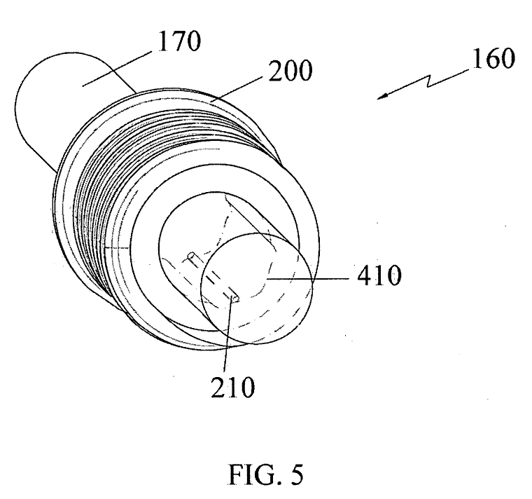

Referring to FIG. 5 through 8, clamp rod 170 is shown in the interior of cylinder 160 with locking device 210 in the deep part of groove 410. As clamp rod 170 is rotated in a first direction, locking device 210, moves towards the shallow side of groove 410 and substantially locks clamp rod 170 to the interior 400 of cylinder 160. This locked position prevents the clamp rod 170 from sliding within the interior 400. If cylinder 160 and hole 220 are threaded, further rotation of the clamp rod 170 in the same direction advances the clamp rod 170 forward due to the threaded extension of the cylinder 160. Rotation of clamp rod 170 in a second direction releases the clamp rod 170 and moves the locking device 210 from the shallow end of groove 410, thereby bringing the clamp rod 160 back to its initial position, where clamp rod 170 can slide within the cylinder 160.

Alternatively, if there are two shallow ends of groove 410, the rotation of clamp rod 170 in the second direction produces the same locking effect within cylinder 160. Further rotation of clamp rod 170 in the same second direction moves the cylinder 160 in the second direction thread-by-thread. Rotating clamp rod 170 in the first direction brings back the clamp rod 170 to the initial position.

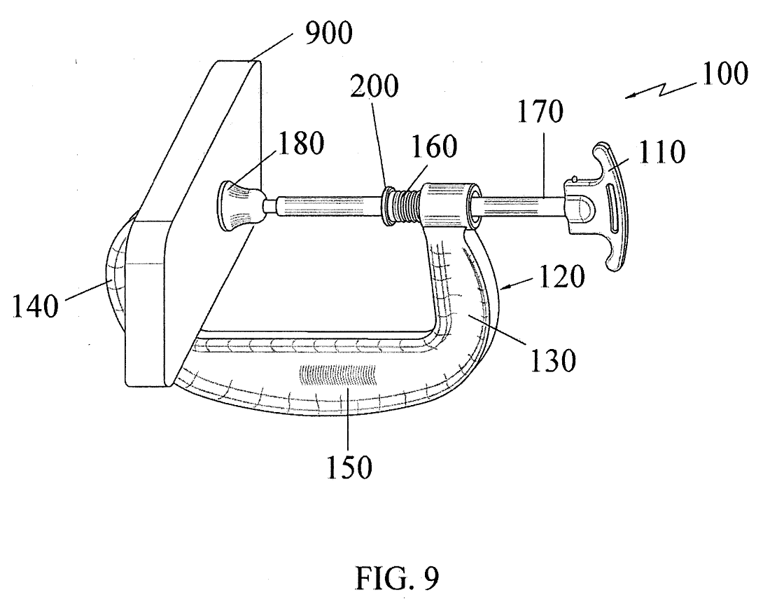

Therefore, to clamp a work piece 900 or a plurality of work pieces as seen in FIG. 9, the clamp rod 170, when in its initial position, is moved until the work piece 900 is gripped between the seat pad 190 and the shoe member 180. Once the work piece 900 is gripped, the handle 110 is rotated in the first direction, which causes the movement of the locking device 210 to the shallow end of groove 410. This locks clamp rod 170 within cylinder 160. Further rotation of handle 110 tightens the grip of the C-clamp 100 over the work piece 900, owing to the forward advancement of the cylinder 160 carrying the clamp rod 170. The handle 110 is to be rotated in the second direction to free the work piece 900.

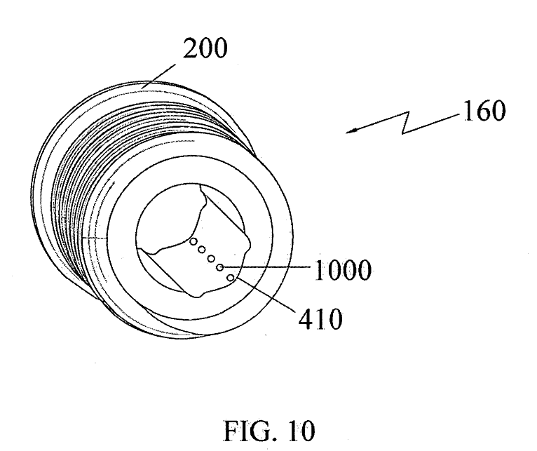

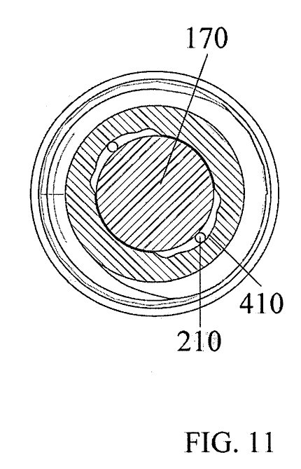

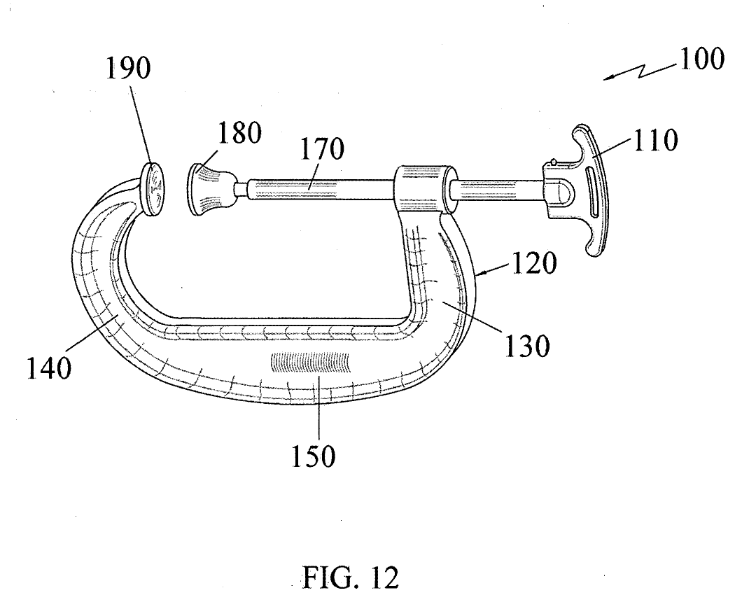

Referring to FIGS. 10 through 12, alternative embodiments of the present invention using a plurality of locking devices 210 in the form of bearings within the grooves 410 instead of the locking device 210 as a rod. In another embodiment, two grooves 410 are provided, each with shallow ends; the grooves 410 being diametrically opposite to each other as seen in FIG. 11. In yet another embodiment of the present invention, the cylinder 160 and the hole 220 is one unit and the locking device 210 and the groove 410 are employed within the hole 220 of the C-frame 120 as seen in FIG. 12.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An adjustable C-clamp comprising:
a C-frame comprising first and second arms, the first and second arms connected by an intermediate arm, the ends of the first and second arms including a seat pad and a hole respectively;
a cylinder comprising a bore to be received within the hole;
the cylinder containing at least one groove on the interior side of the cylinder;
a clamp rod including a shoe member at one of its end, the clamp rod being disposed within the bore such that the seat pad and the shoe member are oppositely faced, the clamp rod to slide within the bore;
the groove containing locking device for securing the clamp rod in position.

2. The C-clamp of claim 1, wherein the groove has a shallow side and a deep side.

3. The C-clamp of claim 1, wherein the seat comprises a gripping surface.

4. The C-clamp of claim 1, wherein the hole is a threaded hole.

5. The C-clamp of claim 1, wherein the cylinder is a threaded cylinder.

6. The C-clamp of claim 1, wherein the groove runs along the length of the cylinder on the bore side.

7. The C-clamp of claim 1, wherein the locking device is ball bearing.

8. The C-clamp of claim 1, wherein the locking device is a rod.

9. The C-clamp of claim 1, wherein the locking device is magnetized.

10. The C-clamp of claim 1, wherein the hole and cylinder is one unit.

11. The C-clamp of claim 1, wherein the clamp rod further includes a handle.

12. The C-clamp of claim 9, wherein the handle is detachable.

13. The C-clamp of claim 1, wherein the C-clamp is made of metal.

14. The C-clamp of claim 1, wherein the clamp rod is made of a material which is sensitive to magnetism.

15. The C-clamp of claim 1, wherein the cylinder is made of rubber.

16. The C-clamp of claim 1, wherein the cylinder is made of plastic.

17. The C-clamp of claim 1, wherein the shoe member and the clamp rod are connected by a ball and socket joint.

18. The C-clamp of claim 1, wherein the shoe member comprises a gripping surface.

19. The C-clamp of claim 1, wherein the number of locking device corresponds to the number of grooves.

20. A method for using the C-clamp of the present invention comprising the steps of:
a. Placing an object to be clamped between the seat pad and shoe member.
b. Moving the clamp rod such that the object to be clamped is securely located between the seat pad and shoe member.
c. Twisting the handle of the clamp rod in a direction such that the locking device is moved to the locking position to securely lock the clamp rod in position.
